(19) United States
(12) Patent Application Publication
(10) Pub. No.: US 2010/0151374 A1
(43) Pub. Date: Jun. 17, 2010

(54) TONER PRODUCT AND METHOD OF FORMING IMAGE

(75) Inventors: Yasuko UCHINO, Tokyo (JP); Tomomi OSHIBA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/630,879

(22) Filed: Dec. 4, 2009

(30) Foreign Application Priority Data
Dec. 11, 2008 (JP) 2008315283

(51) Int. Cl. G03G 13/20; G03G 9/08

(52) U.S. Cl. 430/108.4; 430/124.1

(57) ABSTRACT

A toner product containing a toner and a toner container holding the toner, wherein the toner contains a toner particle having an amount of a carboxyl group present on a surface of the toner particle of 1.0×10⁻⁷-2.5×10⁻⁵ mol/g, the amount of the carboxyl group present on the surface of the toner particle being determined by titrating a dispersion of the toner dispersed in water employing a strongly basic solution as a titration reagent; and the toner container contains a resin containing at least a polylactic acid.

This application is based on Japanese Patent Application No. 2008-315283 filed on Dec. 11, 2008 in Japanese Patent Office, the entire content of which is hereby incorporated by reference.

### TECHNICAL FIELD

The present invention relates to a toner product and to a method of forming an image employing the toner product.

### BACKGROUND

Recently, in the field of forming images with an electrophotographic image forming method, the use of a toner manufactured via an emulsion polymerization association method has been increased in accordance with the requirement for higher quality electrophotographic images. According to the emulsion polymerization association method, a small diameter toner having a sharp particle diameter distribution can be manufactured in an energy-saving manner. The toner manufactured via the emulsion polymerization association method has a polar group on the surface and inside of the toner particle according to the nature of the manufacturing processes thereof. It is known that such a polar group can be effectively utilized to control the electrification of the toner or to control the dispersibility of colorant when its amount is suitably adjusted (refer to Patent Document 1).

Generally, a polyolefin resin such as polyethylene having a relatively small polarity has been used for a container of a toner. However, when a toner containing toner particles having a larger polarity is used with such a container having a smaller polarity, the amount of toner accumulated on the inner wall of the toner container increases since the toner particles are charged by the friction between the toner container and the toner held in the container. As a result, occurred is a problem that the amount of residual toner in the toner container increases when the toner in the toner container is supplied to an image forming apparatus.

In order to solve such a problem, proposed has been a technique in which the triboelectric charge generated by the friction between the toner container and the toner held in the container is reduced by incorporating an antistatic agent in the resin constituting the toner container (for example, refer to Patent Document 2). However, since an antistatic agent generally has a tendency to adsorb a large amount of water, the amount of water adsorbed by the toner container also increases, specifically under a high temperature-high humidity condition, whereby the amount of water adsorbed on the toner held in the toner container also increases, resulting in causing an image defect such as fog in an obtained image.

(Patent Document 1) Japanese Patent Application Publication (hereafter referred to as JP-A) No. 2008-26887

(Patent Document 2) JP-A No. 6-67536

### SUMMARY OF THE INVENTION

In view of the foregoing problems, the present invention was achieved, and an object of the present invention is to provide a toner product which enables to reduce triboelectric charge generated by the friction between a toner container and a toner held in the toner container, to reduce a residual amount of the toner in the toner container when the toner is supplied to an image forming apparatus, as a result of the above, and to form a high quality image without an image defect even under a high temperature-high humidity condition, as well as to provide a method of forming an image employing the toner product.

One of the aspects of the present invention to achieve the above abject is a toner product containing a toner and a toner container holding the toner, wherein the toner contains a toner particle having an amount of a carboxyl group present on a surface of the toner particle of 1.0×10⁻⁷-2.5×10⁻⁵ mol/g, the amount of the carboxyl group present on the surface of the toner particle being determined by titrating a dispersion of the toner dispersed in water employing a strongly basic solution as a titration reagent; and the toner container contains a resin containing at least a polylactic acid.

### BRIEF DESCRIPTION OF THE DRAWING

FIG. 1 is a descriptive schematic drawing illustrating an example of a toner container employed for the toner product of the present invention.

### DESCRIPTION OF THE PREFERRED EMBODIMENTS

According to the toner product of the present invention, due to the use of a toner containing a toner particle having a prescribed amount of carboxyl groups and a toner container containing a resin containing at least a polylactic acid, the residual amount of toner in the toner container when the toner is supplied to an image forming apparatus can be reduced because the amount of the toner electrostatically accumulated on the inner wall of the toner container can be reduced due to the decrease in the triboelectric charge generated by the friction between the toner container and the toner held in the toner container. Further, even under a high temperature-high humidity condition, a high quality image without an image defect such as fog can be obtained since the charging property of the toner particle is not affected, because the amount of adsorbed water to the main body of the toner container is small when the container contains a resin containing a polylactic acid, and because the amount of water adsorbed to the toner is small when the toner particle has a prescribed amount of carboxyl groups. The reason why the triboelectric charge generated by the friction between the toner container and the toner held in the toner container is reduced is assumed to be because the polar group existing on the surface of the toner particle constituting the toner and the polar group of the resin constituting the toner container are electrostatically repulsive since the toner particle has a suitable amount of negative polar groups on the surface of the toner particle and the polylactic acid contained in the resin constituting the toner container has negative polar groups.

Furthermore, according to the toner product of the present invention, the load to environment can be principally reduced by the biodegradable nature of the polylactic acid due to the incorporation of a polylactic acid in the resin contained in the toner container.

The present invention will be concretely explained below.

### [Toner Product]

In the toner product of the present invention, the toner contains a toner particle having an amount of a carboxyl group present on a surface of the toner particle of 1.0×10⁻⁷-2.5×10⁻⁵ mol/g, the amount of the carboxyl group present on the surface of the toner particle being determined by titrating a dispersion of the toner dispersed in water employing a strongly basic solution as a titration reagent, and the toner container contains a resin containing at least a polylactic acid.

### [Toner Container]

The toner container which constitutes the toner product of the present invention contains a resin containing at least a polylactic acid. In the present invention, a polylactic acid is a polymer obtained from L-lactic acid and/or D-lactic acid.

The resin constituting the toner container may contain at least a resin selected from a polycarbonate resin and a polyolefine resin besides a polylactic acid. The resin constituting the toner container may further contain, for example, a flame retarder or an antioxidant, if necessary.

The polycarbonate resin is not specifically limited, however, for example, an aliphatic polycarbonate or an aromatic polycarbonate may be cited. Specific examples of a polyolefine resin include: a very low density polyethylene (VLDPE), a linear low density polyethylene (LLDPE), a low density polyethylene (LDPE), a medium density polyethylene (MDPE), a high density polyethylene (HDPE), polypropylen (PP), an ethylene propylene rubber (EPM), an ethylene vinyl acetate copolymer (EVA), an ethylene acrylate copolymer (EEA). Specifically, an aromatic polycarbonate is preferably used together with a polylactic acid.

The content of the polylactic acid contained in the resin contained in the toner container is preferably 10-90% by mass and more preferably 25-75% by mass. When the content of the polylactic acid exceeds 90 wt %, the strength needed for a toner container may not be obtained. On the contrary, when the content of the polylactic acid is less than 10% by mass, the triboelectric charge generated between the toner container and the toner held in the toner container cannot be fully suppressed.

With respect to the polylactic acid contained in the resin constituting the toner container, the melt flow rate of the polylactic acid is preferably 1-20, and more preferably 1.5-10. When the melt flow rate of the polylactic acid is less than 1, the viscosity of the melt becomes too high, whereby molding of the polylactic acid into a container becomes difficult. On the contrary, when the melt flow rate is larger than 20, the viscosity of the melt becomes too low, whereby it may become difficult to mold of the polylactic acid so that the toner container has a uniform wall thickness. The melt flow rate is measured using a melt indexer under a condition of 190° C. and 2.16 kg.

The wall thickness of the toner container is preferably 0.5-5.0 mm and more preferably 0.5-4.0 mm. When the wall thickness of the toner container is larger than 5.0 mm, the amount of used resin becomes larger than necessary to ensure the strength, whereby the cost will be increased. On the contrary, when the wall thickness of the toner container is less than 0.5 mm, the necessary strength may not be obtained.

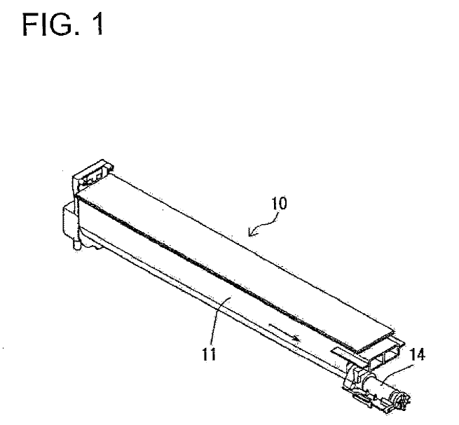

The shape of the toner container is not specifically limited, however, for example, the shape shown in FIG. 1 may be exemplified.

In FIG. 1, toner container 10 has a kind of a box shape having toner supply port 14 at the end of toner container main body 11. Toner bottle 10 is loaded in the housing for the toner container of the image forming apparatus along the longitudinal direction of the toner container main body 11 (the direction of the arrow head in FIG. 1).

The toner container of the present invention can be manufactured by, for example, an injection molding method or a blow molding method. It is specifically preferable that the toner container is manufactured by an injection molding method. An injection molding method is a manufacturing method in which a heat-melted and liquidized resin is forced into a mold cavity using an injection plunger or a screw, where it cools and hardens to the configuration of the mold cavity. The toner container of the present invention may be fabricated by forming each part constituting the toner container by an injection molding method, followed by adhering each other for fixing.

### [Toner]

The amount of carboxyl groups present on the surface of a toner particle contained in the toner used in the toner product of the present invention is 1.0×10⁻⁷-2.5×10⁻⁵ mol/g, and preferably 1.0×10⁻⁷-1.8×10⁻⁵ mol/g. When the toner has an excessive amount of a carboxyl group present on the surface of the toner particle constituting the toner, the obtained image tends to be suffered from fog, specifically under a high temperature-high humidity condition, since the amount of water adsorbed on the toner increases. On the contrary, when the toner has too small amount of carboxyl groups present on the surface of the toner particle constituting the toner, the residual amount of toner in the toner container tends not to be reduced, since the triboelectric charge generated between the toner container and the toner held in the toner container cannot be fully suppressed.

### (Amount of Carboxyl Group)

The amount of a carboxyl group present on the surface of a toner particle constituting the toner can be controlled by adjusting, for example, a composition ratio of monomers having a carboxyl group, for example, an acrylic acid monomer or a methacrylic acid monomer, or by adjusting the composition in the polymerization reaction during toner preparation, in the case of a resin formed via an addition-polymerization reaction. Further, in the case of a resin formed via a polycondensation reaction, it is controlled by introducing a polyfunctional acid, for example, a trimellitic acid to suppress the development of cross-linking reaction, or by adjusting a ratio of an alcohol component to an acid component at the polymerization step.

The amount of a carboxyl group present on the surface of a toner particle constituting the toner is determined via titration. As for the titration, the toner is dispersed in water, and a titration curve is prepared by changing electrical properties such as electrical conductivity, pH and so forth employing a strongly basic solution as a titration reagent, for example, a sodium hydroxide solution to calculate and determine the amount. Specifically, 5.0 g of toner is charged in a beaker, and 45.0 g of an aqueous solution of 1% sodium dodecyl sulfate is added therein to prepare a dispersion of the sample. The sample dispersion is titrated with a 0.01 N sodium hydroxide aqueous solution employing an electrical conductivity measuring apparatus (ABU91 Autoburett and CDM 80 Conductivity Meter, manufactured by Radiometer Co., Ltd.), and an amount of sodium hydroxide employed to neutralize the carboxyl group is read out from the titration curve. When the amount of an aqueous sodium hydroxide solution is Y mL, the total amount of carboxyl group in the sample dispersion Mt is calculated as shown in the following Formula (1).

Mt=0.01×Y×10⁻³ (mol) Formula (1)

Accordingly, the amount of carboxyl group per unit weight of toner A (mol/g) is calculated from the following Formula (2).

A=Mt/5 (mol/g) Formula (2)

### (Method of Manufacturing Toner)

Examples of a method of manufacturing toner utilized for a toner product of the present invention include a kneading-pulverizing method, a suspension polymerization method, an emulsion polymerization method, an emulsion polymerization coagulation method, an encapsulation method, and other commonly known methods. In consideration of acquisition of a toner having a minimized particle diameter in order to achieve high image quality, the emulsion polymerization coagulation method is preferably used specifically in view of manufacturing cost and manufacturing stability.

The emulsion polymerization coagulation method is a method by which a dispersion of particles composed of a binder resin produced via an emulsion polymerization method (hereinafter, referred to as “binder resin particles”) is mixed with a dispersion of other particle constituting the toner particle, such as a colorant particle, and the particles are slowly coagulated while balancing repulsive force of particle surfaces obtained via pH adjustment and coagulating force obtained via addition of a coagulant formed of an electrolyte, and coagulation is conducted while controlling the average particle diameter and the particle diameter distribution. Shape control is simultaneously conducted via interparticle fusion by applying heat while stirring. Thus, the toner particles are manufactured.

When binder resin particles are formed by the emulsion polymerization coagulation method as a method of manufacturing toner, the resin particle may have a structure of at least two layers composed of binder resins each having a different composition. This structure can be obtained by a method in which a polymerization initiator and a polymerizable monomer are added into a dispersion of the first resin particles prepared via a conventional emulsion polymerization treatment (the first stage polymerization), followed by polymerizing the monomers (the second stage polymerization).

One example of a method of manufacturing a toner employing an emulsion polymerization coagulation method will be specifically described. The method contains the following processes:

(1) Colorant particle dispersion formation process to obtain colorant particles in which a surfactant, if desired, is contained;

(2) Binder resin particle polymerization process to obtain binder resin particles in which such as an off-set inhibitor and a charge control agent, if desired, are contained.

(3) Salting-out/coagulation/fusion process to form toner particles via salting-out, coagulation and fusion of binder resin particles and colorant particles in an aqueous medium;

(4) Filtration/washing process to remove such as the surfactant from toner particles by filtering the toner particles from the dispersion (aqueous medium) of the toner particles;

(5) Drying process to dry toner particles having been subjected to a washing treatment; and

(6) Process of adding external additives into the toner particle having been subjected to a drying treatment.

Herein, “aqueous medium” means a medium containing 50-100% by mass of water and 0-50% by mass of a water-soluble organic solvent. Examples of the water-soluble organic solvent include methanol, ethanol, isopropanol, butanol, acetone, methyl ethyl ketone and tetrahydrofuran, and an alcohol based organic solvent which does not dissolve the resulting resin is preferable.

### (Colorant)

A commonly known inorganic or organic colorant is usable as a colorant constitution the toner. Further, the addition amount of the colorant is 1-30% by mass, based on the total mass of toner, and preferably 2-20% by mass.

### (Binder Resin)

A thermoplastic resin exhibiting sufficient adhesion to a colorant particle is preferably employed as a binder resin constituting a toner, and a solvent-soluble resin is more preferably employed. Further, even a curable resin to form a three-dimensional structure is usable, when the precursor is solvent-soluble. As a binder constituting the toner, a binder resin selected in consideration of a high electrification property and a high fixing property, in addition to the above conditions is preferably used. Such the binder resin which is commonly used as the binder resin constituting the toner is usable without limitation, and specific examples thereof include: a styrene resin, an acrylic resin such as alkyl acrylate or alkyl methacrylate, a styrene-acrylic copolymer resin, a polyester resin, a silicone resin, an olefin resin, an amide resin and an epoxy resin. Of these, a styrene resin, an acrylic resin, a styrene-acrylic copolymer resin and a polyester resin are preferably employed in order to improve transparency and color reproduction of superimposed images, since these resins exhibit high transparency and a high sharp-melt property while exhibiting a low melt viscosity. A styrene-acrylic copolymer resin is specifically preferable because it gives a specifically high effect. These resins may be used alone or in combination of 2 or more kinds of resins.

Usable examples of polymerizable monomers to obtain the toner binder resin include styrene based monomers such as styrene, methylstyrene, methoxystyrene, butylstyrene, phenylstyrene, chlorostyrene and so forth; (meth)acrylate ester based monomers such as methyl (meth)acrylate, ethyl (meth)acrylate, butyl (meth)acrylate, ethylhexyl (meth)acrylate and so forth; and carboxylic acid based monomers such as an acrylic acid, a methacrylic acid fumaric acid and so forth; and so forth. These can be used singly or in combination with at least 2 kinds.

The binder resin constituting toner preferably has a glass transition temperature (Tg) of 30-50° C. When a glass transition temperature (Tg) of the binder resin is lower than 30° C., the resulting toner can not exhibit sufficient heat resistance, and coagulation of toner-to-toner tends to be generated.

The glass transition temperature of the binder resin is determined employing a differential scanning calorimeter (DSC-7, produced by PERKIN ELMER, Inc.) and a thermal analyzer controller (TAC7/DX, produced by PERKIN ELMER, Inc.). Specifically, 4.50 mg of a sample is sealed in an aluminum pan (KIT No. 0219-0041), and this is placed in a DSC-7 sample holder. A derivative curve of the resulting curve C_{2nd} is determined to read peak top temperature Tₚ (° C.) on the lowest temperature side at 20° C. or more concerning the derivative curve. An empty aluminum pan is used for the reference measurement. Subsequently, heating-cooling-heating temperature control is conducted under the measuring conditions of a temperature increasing rate of 10° C./min and a temperature decreasing rate of 10° C./min in the measurement temperature range of 0-200° C. to obtain data during the second heating. An intersection point of tangents at temperature Tₚ of C_{2nd} and at a temperature in the range of Tₚ-20° C. is designated as a glass transition temperature. In addition, when temperature Tₚ cannot be clearly read out, an intersection point of an extension of the endothermic side inflection point on the lowest temperature side at 20° C. or more concerning C_{2nd} or the base line before the initial rise of the endothermic peak, and an tangent showing the maximum inclination between the initial rising position of the first endothermic peak and the peak top is designated as the glass transition temperature. Incidentally, when raising temperature during the first heating, the temperature is maintained at 200° C. for one minute.

Further, the binder resin preferably has a softening temperature of 80-130° C., and more preferably has a softening temperature of 90-120° C.

### (Polymerization Initiator)

When the toner is manufactured via an emulsion polymerization coagulation method, as a polymerization initiator to obtain a binder resin, usable is a water-soluble polymerization initiator. Specific examples of the polymerization initiator include persulfate such as potassium persulfate, ammonium persulfate or the like, an azo based compound such as 4,4′-azobis4-cyano valerate, a salt thereof, a 2,2′-azobis(2-amidinopropane) salt, a peroxide compound and so forth.

### (Chain Transfer Agent)

When the toner is manufactured via an emulsion polymerization coagulation method, usable is a commonly known chain transfer agent. The chain transfer agent is not specifically limited, and examples thereof include 2-chloroethanol, mercaptan such as octyl mercaptan, dodecyl mercaptan, t-dodecyl mercaptan or the like, a styrene dimer and so forth.

### (Surfactant)

Examples of surfactants employed when preparing toner by an emulsion polymerization coagulation method include various commonly known ionic and nonionic surfactants, and so forth.

### (Coagulant)

Examples of coagulants employed when preparing toner by an emulsion polymerization coagulation method include alkali metal salts, alkaline earth metal salts and so forth. Examples of the alkali metal constituting the coagulant include lithium, potassium, sodium and so forth, and examples of the alkaline earth metal constituting the coagulant include magnesium, calcium, strontium, barium and so forth. Of these, potassium, sodium, magnesium, calcium and barium are preferable. Examples of a counter ion (namely an anion constituting a salt) of the alkali metal or alkaline earth metal include chloride ion, bromide ion, iodide ion, carbonate ion, sulfate ion and so forth.

### (Off-Set Inhibitor)

An off-set inhibitor may be contained in toner in order to inhibit an off-set phenomenon. Herein, the off-set inhibitor is not specifically limited, and examples thereof include polyethylene wax, oxidization-type polyethylene wax, polypropylene wax, oxidization-type polypropylene wax, carnauba wax, fatty acid ester wax, sasol wax, rice wax, candelilla wax, jojoba wax, bees wax and so forth.

Examples of the method to contain an off-set inhibitor in a toner particle include a method by which a dispersion of off-set inhibitor particles (wax emulsion) is added in the salting-out/coagulation/fusion process to form toner particles, and binder resin particles, colorant particles and off-set inhibitor particles are subjected to salting-out/coagulating/fusing; and a method by which colorant particles and binder resin particles containing a off-set inhibitor are subjected to salting-out/coagulating/fusing in the salting-out/aggregation/fusion process to form toner particles. These methods may be used in combination. The content of an off-set inhibitor in the toner is commonly 1-30 parts by mass, based on 100 parts by mass of a toner particle forming binder resin, and preferably 5-20 parts by mass, based on 100 parts by mass of a toner particle forming binder resin.

### (Charge Control Agent)

A charge control agent may be contained in toner. Examples of the charge control agent include a zinc or aluminum metal complex of a salicylic acid (salicylic acid metal complex), a calixarene based compound, an organic boron compound, a fluorine-containing quaternary ammonium salt compound and so forth. The content of the charge control agent in the toner particle is commonly 0.1-5.0 parts by mass, based on 100 parts by mass of a binder resin.

### (Particle Diameter of Toner Particle)

The toner particles preferably have a volume-based median particle diameter of 3-10 μm, and more preferably have a volume-based median particle diameter of 4-8 μm. When the method of manufacturing toner is an emulsion polymerization coagulation method, this volume-based median particle diameter can be controlled by the concentration of a utilized coagulant (salting-out agent) used, the addition amount of an organic solvent, the fusing time, or the composition of a polymer. When the volume-based median particle diameter falls within the above range, half-tone image quality is improved by increasing the transfer efficiency, and image quality in fine line as well as dot is improved.

The above-described volume-based median particle diameter (D₅₀) of toner particles can be measured and calculated by using an apparatus in which a computer system for data processing is connected to MULTISIZER 3 (manufactured by BECKMAN COULTER Inc.). Specifically, after 20 ml of the surfactant solution (surfactant solution in which a neutral detergent containing a surfactant is diluted with pure water by 10 times) is mixed with 0.02 g of toner, the mixture is subjected to an ultrasonic dispersion for one minute to obtain a toner dispersion. This toner dispersion is then poured, using a pipette, in a beaker containing ISOTON II (produced by Beckman Coulter Inc.) placed in a sample stand, until the measured content reaches 5-10% by mass, and a counter is set to 25000 counts to be measured. In addition, a 50 μm aperture diameter of Multisizer 3 is used.

### (External Additive)

In order to improve fluidity, electrification, and a cleaning property, external additives such as a fluidizer, a cleaning aid and so forth may be added into the toner particles to constitute the toner.

Examples of external additive particles include inorganic oxide particles such as silica particles, alumina particles, titanium oxide particles and so forth; inorganic stearic acid compound particles such as aluminum stearate particles, zinc stearate particles and so forth; or inorganic titanic acid compound particles such as strontium titanate, zinc titanate and so forth. These can be used singly or in combination with at least 2 kinds. These inorganic particles are preferably subjected to a surface treatment employing a silane coupling agent, a titanium coupling agent, a higher fatty acid, silicone oil or the like in order to enhance heat-resistant storage stability and environmental stability.

The total addition amount of these various external additives is 0.1-10 parts by mass, based on 100 parts by mass of the toner. In addition, various kinds of external additives may be used in combination.

### (Developer)

The toner employed for a toner product of the present invention can be used as a magnetic or non-magnetic single-component developer, but may be used as a two-component developer by mixing with a carrier. When the toner is used as a two-component developer, magnetic particles made of a conventionally known material such as metal such as iron, ferrite, magnetite or the like, as well as alloy of the forgoing metals each with metal such as aluminum, lead or the like are usable as a carrier, but ferrite particles are specifically preferable. Further, a coat carrier in which the surface of the magnetic particle is coated with a coating agent such as a resin or the like, a binder-type carrier obtained by dispersing magnetic material powder in a binder resin, and so forth are also usable as the carrier. A coating resin to form the coat carrier is not specifically limited, but examples thereof include olefin based resins, styrene based resins, styrene-acrylic resins, acrylic resins, silicone based resins, ester resins, fluorine resins and so forth. Further, those commonly known can be used as the binder resin constituting a binder type carrier specifically with no limitation, and usable examples thereof include styrene-acrylic resins, polyester resins, fluorine resins, phenol resins and so forth. Of these, the coat carrier coated with the styrene-acrylic resin or acrylic resin is preferable in view of electrification and durability.

The carrier preferably has a volume average particle diameter of 20-100 μm, and more preferably has a volume average particle diameter of 25-80 μm in order to acquire high-quality images, and to suppress carrier fog. The volume average particle diameter of the carrier can be measured typically with a laser diffraction type particle size distribution measuring apparatus (HELOS, manufactured by SYMPATEC Co.) equipped with a wet-type homogenizer.

According to the toner product as described above, due to the use of a toner containing a toner particle having a prescribed amount of carboxyl groups and a toner container containing a resin containing at least a polylactic acid, the residual amount of toner in the toner container when the toner is supplied to an image forming apparatus can be reduced because the amount of the toner electrostatically accumulated on the inner wall of the toner container can be reduced due to the decrease in the triboelectric charge generated by the friction between the toner container and the toner held in the toner container. Further, even under a high temperature-high humidity condition, a high quality image without image defect such as fog can be obtained since the toner has an excellent charging property due to the presence of appropriate amount of polar groups in the toner.

Further, the load to environment can be principally reduced by the biodegradable nature of the polylactic acid due to the incorporation of a polylactic acid in the resin contained in the toner container.

### (Image Forming Method)

It is also one of the features of the present invention that the toner product of the present invention is installed in an image forming apparatus and supplies the toner held in the toner container to the developing device of the image forming apparatus, when the toner in the developing device is consumed.

The method of forming an image according to the present invention contains the steps of: charging an image carrier to provide an evenly charged potential on the image carrier; exposing the image carrier having the evenly charged potential to light to form an electrostatic latent image on the image carrier; developing the electrostatic latent image with a toner supplied from the toner product of the present invention to visualize the latent image into a toner image; transferring the toner image onto a transfer material; and fixing the toner image on the transfer material.

### EXAMPLE

Next, specific examples of the present invention will be described, but the present invention is not limited thereto.

### Toner Preparation Example 1

### Preparation of Resin Particles

### (1) The First Stage Polymerization

A solution in which 8 g of dodecyl sodium sulfate was dissolved in 3 L of deionized water was charged in a 5 L reaction vessel equipped with a stirring device, a temperature sensor, a cooling tube and a nitrogen introducing device, and the liquid temperature was raised to 80° C. while stirring at a stirring speed of 230 rpm under a nitrogen flow. After raising the temperature, a solution in which 10 g of potassium persulfate was dissolved in 200 g of deionized water was added into the system, and the liquid temperature was again set to 80° C. Then, the following monomer mixture solution was added dropwise, spending one hour. Subsequently, the system was heated at 80° C. for 2 hours while stirring to conduct polymerization, whereby resin particle [1H] was prepared.

| | |
|---|---|
| Styrene | 480 g |
| n-butylacrylate | 250 g |
| Methacrylic acid | 68 g |
| n-octyl-3-mercaptopropionate | 16 g |

### (2) The Second Stage Polymerization

A solution in which 7 g of polyoxyethylene-2-dodecyl ether sodium sulfate was dissolved in 800 mL of deionized water was charged in a 5 L reaction vessel equipped with a stirring device, a temperature sensor, a cooling tube and a nitrogen introducing device. After heating the system at 98° C., a solution in which 260 g of the above-described resin particle [1H] and the following monomer solution were dissolved at 90° C. was added into the system, and mixed while dispersing for one hour employing a mechanical homogenizer (CLEARMIX, manufactured by M•Technique Co., Ltd.) equipped with a circulation path to prepare a dispersion containing emulsified particles (oil droplets).

| | |
|---|---|
| Styrene | 245 g |
| n-butylacrylate | 120 g |
| n-octyl-3-mercaptopropionate | 1.5 g |
| Pentaerythritol tetrabehenic acid ester | 190 g |

Next, an initiator solution in which 6 g of potassium persulfate were dissolved in 200 mL of deionized water was added into this dispersion, and this system was heated and polymerized at 82° C. while stirring for one hour to prepare resin particle [1HM].

### (3) The Third Stage Polymerization

Further, a solution in which 11 g of potassium persulfate were dissolved in 400 g of deionized water was added, and the following monomer mixture solution was added dropwise, spending one hour. After completion of adding, the system was heated for 2 hours while stirring to conduct polymerization and subsequently cooled down to 28° C., whereby resin particle [1] was obtained.

| | |
|---|---|
| Styrene | 456 g |
| n-butylacrylate | 135 g |
| Methacrylic acid | 9 g |
| n-octyl-3-mercaptopropionate | 8 g |

### (Preparation of Colorant Dispersion)

In 1600 mL of deionized water, dissolved was 90 g of sodium dodecylsulfate while stirring. Into the resulting solution, gradually added was 420 g of carbon black (Regal 330R, produced by Cabot Co.) as a colorant, and subsequently dispersed employing a stirrer (CLEARMIX, M•TECHNIQUE Co., Ltd.) to prepare a colorant particle dispersion (hereinafter, referred to as “colorant dispersion [1]”). The particle diameter of the colorant particles of “colorant dispersion [1]”, which was measured employing an electrophoretic light scattering photometer (ELS-800, manufactured by OTSUKA DENSHI Co., Ltd.), was 110 nm.

### (Coagulation•Fusion Process)

A solution in which 300 g of resin particle [1] in solid content conversion, 1400 g of deionized water, 120 g of colorant dispersion [1] and 3 g of polyoxyethylene-2-dodecylether sodium sulfate were dissolved in 120 mL of deionized water was charged in a 5 L reaction vessel fitted with a stirring device, a temperature sensor, a cooling tube and a nitrogen introducing device, and after the liquid temperature was set to 30° C., and pH was adjusted to 10 via addition of an aqueous 5N sodium hydroxide solution. Subsequently, an aqueous solution in which 35 g of magnesium chloride were dissolved in 35 mL of deionized water was added into the system at 30° C. over 10 minutes while stirring. After standing for 3 minutes, the system was raised to 90° C. spending 60 minutes and the particle growth reaction was continued while keeping the temperature at 90° C. In this situation, the particle diameter of associated particles was measured with Multisizer 3, manufactured by Beckman Coulter Inc., and when reaching the desired particle diameter, an aqueous solution in which 150 g of sodium chloride were dissolved in 600 g of deionized water was added to terminate the particle growth. Further, the inter-particle fusion was accelerated until reaching a circularity of 0.965 via measurement employing “FPIA-2100” (manufactured by SYSMEX Corp.) by conducting a fusion process at a liquid temperature of 98° C. while stirring. Subsequently, the system was cooled down to 30° C., and pH was adjusted to 4 by adding hydrochloric acid. Then, the stirring was stopped.

### (Washing-Drying Process)

Particles prepared in the coagulation•fusion process were solid/liquid-separated via suction-filtration employing a Nutshe to form a wet cake as toner base particles. This wet cake was washed with deionized water at 35° C. via the foregoing suction-filtration until the filtrated liquid reached 5 μS/cm in electrical conductivity, and then moved to “Flash Jet Dryer” produced by SEISHIN ENTERPRISE Co., Ltd. and dried until the water content reached 0.5% by mass to prepare toner base particle [1].

### (External Additive Treatment Process)

One part by mass of hydrophobic silica (a number average primary particle diameter of 12 nm) and 0.3 parts by mass of hydrophobic titanic (a number average primary particle diameter of 20 nm) were added into 100 parts by mass of above-described toner base particle [1], followed by mixing the system employing a HENSCHEL MIXER to prepare toner [1].

### Toner Preparation Example 2-7

Toners [2]-[7] were prepared similarly to toner preparation example 1, except that the charging amount of the monomer mixing liquid in the third stage polymerization was changed as shown in Table 1. Further, values obtained by measuring and determining the amount of carboxyl group present on the surface of the toner particle constituting each of toners [1]-[7] are shown in Table 1.

TABLE 1

| | | | | | Carboxyl |
|---|---|---|---|---|---|
| | | | | n-octyl-3- | group on |
| | | n-butyl- | Methacrylic | mercapto- | the toner |
| Toner | Styrene | acrylate | acid | propionate | surface |
| No. | (g) | (g) | (g) | (g) | (mol/g) |
| Toner [1] | 456 | 135 | 9 | 8 | 1.0 × 10⁻⁷ |
| Toner [2] | 453 | 135 | 12 | 8 | 1.6 × 10⁻⁶ |
| Toner [3] | 420 | 144 | 36 | 8 | 1.0 × 10⁻⁵ |
| Toner [4] | 393 | 153 | 54 | 8 | 1.7 × 10⁻⁵ |
| Toner [5] | 372 | 156 | 72 | 8 | 2.0 × 10⁻⁵ |
| Toner [6] | 462 | 132 | 6 | 8 | 2.3 × 10⁻⁸ |
| Toner [7] | 348 | 162 | 90 | 8 | 2.7 × 10⁻⁵ |

### Developer Preparation Examples 1-7

Loaded into a high speed mixer equipped with a stirring blade were 100 mass parts of ferrite core particles and 5 mass parts of cyclohexylmethacrylate/methylmethacrylate copolymer resin particles (copolymer ratio of 5/5), and the mixture was mixed for 30 minutes at 120° C. while stirring to obtain a ferrite carrier having a volume average particle diameter of 40 μm by forming a resin coat layer on the surface of each ferrite core particle by means of a mechanical impactive force. Each of toners [1]-[7] was mixed with the ferrite carrier obtained as described above using a V-type mixer so as to give a toner content of 6%. Thus, toner developers [1]-[7] were prepared.

### Toner Container Preparation Examples 1-9

In accordance with resin compositions and composition ratios shown in Table 2, each of toner containers [1]-[10] for BIZHUB C353 (produced by KONICA MINOLTA BUSINESS TECHNOLOGIES, Inc.) having a shape shown in FIG. 1 was prepared by an injection molding method. The wall thickness of each of toner containers [1]-[9] was 1.5 mm.

TABLE 2

| | Polylactic acid | | Other resin | |
|---|---|---|---|---|
| Toner | Ratio | Melt | | Ratio |
| Container | (mass | flow | | (Mass |
| No. | parts) | rate | Kind | parts) |
| Toner container [1] | 100 | 8.0 | — | — |
| Toner container [2] | 90 | 8.0 | Polycarbonate | 10 |
| Toner container [3] | 75 | 8.0 | Polycarbonate | 25 |
| Toner container [4] | 50 | 8.0 | Polycarbonate | 50 |
| Toner container [5] | 50 | 3.0 | Polycarbonate | 50 |
| Toner container [6] | 25 | 8.0 | Polycarbonate | 75 |
| Toner container [7] | 10 | 8.0 | Polycarbonate | 90 |
| Toner container [8] | 50 | 8.0 | Polypropylene | 50 |
| Toner container [9] | — | — | Polystyrene | 100 |

### Examples 1-12 and Comparative Examples 1-3

The following evaluations (1)-(3) were carried out on the toner products obtained by using toners [1]-[7] and toner containers [1]-[9], obtained as described above, in combinations shown in Table 3.

### (1) Residual Amount of Toner

A toner container loaded with 400 g of toner was set to a single operating unit for a toner container. A weight scale was placed beneath the toner supply port which was left open. The single operating unit was operated under a condition of 20° C. and 50% RH. The amount of toner discharged on the weight scale A (g) was recorded when no weight change of the weight scale was observed while operating the single operating unit. Here, the single operating unit can compulsorily discharge the toner from the toner supply port by rotating the toner conveyance screw of the toner container from outside. The residual amount of toner B (%) can be obtained by following Formula (3). The smaller the value of B (%) is, the less the residual amount of toner in the toner container is. If the value of B (%) is 2.0% or less, there will be practically no problem.

B(%)=(400−A)/400*100 Formula (3)

### (2) Fog

Using A4-sized high quality paper sheets (64 g/m²), 10,000 prints of an original image having a coverage rate of 10% (coverage rate due to a character image of 5%, coverage rate due to a solid image of 5%, while a character image part, a solid black part and a white part each occupies ⅓ of the total sheet) were formed with an intermittent mode of one by one using a toner product of which combination the toner and the toner container was shown in Table 3, under a condition of 30° C. and 80% RH. The fog density of the 10,000th print was measured according to the method described below. BIZHUB C353 (produced by KONICA MINOLTA BUSINESS TECHNOLOGIES, Inc.) was used as an image forming apparatus.

The fog density measurement was carried out using MACBETH Reflective Densitometer “RD-918” as follows: initially, the absolute image densities at 12 random points on unprinted white paper were measured and averaged to obtain a white paper density; thereafter, the absolute image densities at 12 random points in the white portions of the 10,000th print were measured in the same way, and averaged to obtain an average density. A value, obtained by subtracting the white paper density from the average density, was evaluated as the fog density.

In cases in which the fog density is 0.010 or less, there will be practically no problem.

### (3) Drop Test

Each of the toner containers [1]-[9] was filled with 400 g of the toner, and dropped 20 times on a concrete floor from a height of the lowest portion of the toner container of 1 m by holding the both ends of the toner container horizontally with both hands. The existence of a damage in the outside of the toner container (for example, crack, breakage or dent) or leakage of the toner was checked visually after each drop test. If no damage was found after the 10th drop test, the toner container was considered to be practically no problem.

TABLE 3

| | | | Residual | | |
|---|---|---|---|---|---|
| | Toner | | amount of | Fog | |
| | Container | Toner | toner [%] | Density | Drop test |
| Example 1 | [1] | [3] | 0.2 | 0.003 | Crack after 12th |
| | | | | | drop test |
| Example 2 | [2] | [3] | 0.2 | 0.003 | Crack after 18th |
| | | | | | drop test |
| Example 3 | [3] | [3] | 0.3 | 0.002 | No damage |
| Example 4 | [4] | [3] | 0.5 | 0.002 | No damage |
| Example 5 | [5] | [3] | 0.6 | 0.001 | No damage |
| Example 6 | [6] | [3] | 0.7 | 0.001 | No damage |
| Example 7 | [7] | [3] | 1.8 | 0.001 | No damage |
| Example 8 | [8] | [3] | 1.2 | 0.002 | No damage |
| Example 9 | [4] | [1] | 1.0 | 0.001 | No damage |
| Example 10 | [4] | [2] | 0.8 | 0.001 | No damage |
| Example 11 | [4] | [4] | 0.4 | 0.005 | No damage |
| Example 12 | [4] | [5] | 0.4 | 0.008 | No damage |
| Comparative | [4] | [6] | 2.2 | 0.007 | No damage |
| Example 1 | | | | | |
| Comparative | [4] | [7] | 0.4 | 0.016 | No damage |
| Example 2 | | | | | |
| Comparative | [9] | [3] | 2.8 | 0.004 | No damage |
| Example 3 | | | | | |

As shown above, it was confirmed that, in Examples 1-12 according to the present invention, the residual amount of toner could be reduced and high quality images without fog could be obtained even under a high temperature-high humidity condition.

What is claimed is:

1. A toner product comprising a toner and a toner container holding the toner,
wherein
the toner comprises a toner particle having an amount of a carboxyl group present on a surface of the toner particle of 1.0×10⁻⁷-2.5×10⁻⁵ mol/g, the amount of the carboxyl group present on the surface of the toner particle being determined by titrating a dispersion of the toner dispersed in water employing a strongly basic solution as a titration reagent; and
the toner container comprises a resin comprising at least a polylactic acid.

2. The toner product of claim 1,
wherein the resin comprised in the toner container comprises at least a resin selected from a polycarbonate resin and a polyolefin resin.

3. The toner product of claim 1,
wherein a content of the poly lactic acid in the resin is 10 to 90% by mass.

4. The toner product of claim 1,
wherein the amount of the carboxyl group present on the surface of the toner particle is 1.0×10⁻⁷-1.8×10⁻⁵ mol/g.

5. The toner product of claim 1,
wherein the toner is manufactured by an emulsion polymerization coagulation method.

6. The toner product of claim 1,
wherein a wall thickness of the toner container is 0.5 to 5.0 mm.

7. The toner product of claim 1,
wherein a wall thickness of the toner container is 0.5 to 4.0 mm.

8. A method of forming an image comprising the steps of:
(a) charging an image carrier to provide an evenly charged potential on the image carrier;
(b) exposing the image carrier to light to form an electrostatic latent image on the image carrier with the evenly charged potential;
(c) developing the electrostatic latent image with the toner supplied from the toner product of claim 1 to visualize the electrostatic latent image into a toner image;
(d) transferring the toner image onto a transfer material; and
(e) fixing the toner image on the transfer material.
